(19) United States
(12) Patent Application Publication
(10) Pub. No.: US 2026/0369919 A1
(43) Pub. Date: Nov. 19, 2026

(54) ELECTRICAL CONNECTOR

(71) Applicant: Molex, LLC, Lisle, IL (US)

(72) Inventors: Jing-Shan Hou, Shanghai (CN); Xue-Qing Zhang, Shanghai (CN)

(21) Appl. No.: 19/671,312

(22) Filed: May 8, 2026

(30) Foreign Application Priority Data
May 13, 2025 (CN) 202510616164.5

(51) Int. Cl. H01R 13/506

(52) U.S. Cl. CPC H01R 13/506

(57) ABSTRACT

An electrical connector includes: a plurality of conductive terminals, each conductive terminal includes a first terminal portion which extends along a first direction and a second terminal portion which extends along a second direction, the first direction and the second direction therebetween have an angle; a housing, the housing is provided with a plurality of terminal receiving cavities, each conductive terminal is provided in the corresponding terminal receiving cavity, a rear end of the housing is provided with an opening; a baffle provided in the opening of the housing, the baffle is configured to separate the plurality of conductive terminals; and a cover assembled to the rear end of the housing, the cover at least partially covers the opening. The electrical connector meets mounting requirement of a non-vertical electrical connector and more facilitates mounting and use.

### CROSS-REFERENCE TO RELATED APPLICATIONS

This application claims priority to Chinese Patent Application No. 202510616164.5, entitled “Electrical Connector” filed May 13, 2025, which is hereby incorporated by reference in its entirety.

### TECHNICAL FIELD

The present disclosure relates to technical field of connectors, and specifically relates to an electrical connector.

### BACKGROUND

An electrical connector generally includes a housing and a plurality of conductive terminals, the conductive terminal is mounted in a terminal receiving cavity of the housing, the conductive terminal includes a conductive contacting portion and a cable connecting portion, the conductive contacting portion is used to establish electrical connection with another electrical connector, the cable connecting portion is used to establish electrical connection with a cable. Existing electrical connectors may be classified into a vertical electrical connector and a non-vertical electrical connector which are respectively adapted to different application circumstances. A housing of the vertical electrical connector usually is a component which is integral formed, a terminal receiving cavity of the housing penetrates along a front-rear direction, a conductive terminal is inserted into the housing from a rear end of the housing, a conductive contacting portion of the conductive terminal extends toward the front of the housing, a cable connecting portion of the conductive terminal extends toward the rear of the housing. But a cable connecting portion and a conductive contacting portion of a conductive terminal of the non-vertical electrical connector therebetween form a certain angle, for example, an angle between a cable connecting portion and a conductive contacting portion of a conductive terminal of a right-angle electrical connector is about 90 degrees, the conductive contacting portion extends toward the front of a housing, and the cable connecting portion extends along an up-down direction of the housing, a housing which is integrally formed cannot meet mounting requirement of the conductive terminal in the non-vertical electrical connector.

### SUMMARY

With respect to the problem in prior art, an object of the present disclosure is to provide an electrical connector which meets mounting requirement of a non-vertical electrical connector and more facilitates mounting and use.

An embodiment of the present disclosure provides an electrical connector, comprising: a plurality of conductive terminals, each conductive terminal comprises a first terminal portion which extends along a first direction and a second terminal portion which extends along a second direction, the first direction and the second direction therebetween have an angle; a housing, the housing is provided with a plurality of terminal receiving cavities, each conductive terminal is provided in the corresponding terminal receiving cavity, a rear end of the housing is provided with an opening; a baffle provided in the opening of the housing, the baffle is configured to separate the plurality of conductive terminals; and a cover assembled to the rear end of the housing, the cover at least partially covers the opening.

In some embodiments, the plurality of conductive terminal comprise multiple first conductive terminals which are arranged along a width direction, the baffle comprises multiple baffle blocks, the multiple baffle blocks are configured to separate the second terminal portions of the multiple first conductive terminals.

In some embodiments, the second terminal portion of each first conductive terminal comprises a conductive connecting portion and a cable fixing portion which are arranged along the second direction, each baffle block comprises a first cooperating portion and a second cooperating portion which are arranged along the second direction, the first cooperating portion and the conductive connecting portion face each other in the width direction, the second cooperating portion and the cable fixing portion face each other in the width direction; a width of the conductive connecting portion is less than a width of the cable fixing portion, a width of the first cooperating portion is larger than a width of the second cooperating portion.

In some embodiments, each baffle block further comprises a first position-limiting portion and a second position-limiting portion, the first position-limiting portion is positioned at a side of the first cooperating portion away from the second cooperating portion, and the first position-limiting portion is configured to stop the conductive connecting portion in the second direction; the second position-limiting portion is positioned at a side of the second cooperating portion away from the first cooperating portion, and the second position-limiting portion is configured to stop the cable fixing portion in the second direction.

In some embodiments, the conductive terminal comprises multiple first conductive terminals and multiple second conductive terminals, the second terminal portions of the multiple second conductive terminals are positioned in front of the second terminal portions of the multiple first conductive terminals; the baffle comprises a baffle body, the baffle body is configured to separate the second terminal portions of the multiple first conductive terminals and the second terminal portions of the multiple second conductive terminals.

In some embodiments, a front side surface of the baffle body is provided with at least one partitioning structure, each partitioning structure is a recessed groove.

In some embodiments, the opening of the housing is provided therein with at least one positioning cavity which extends along a width direction and at least one positioning groove which extends along the second direction, the baffle comprises at least one first positioning portion and at least one second positioning portion, each first positioning portion is provided in the corresponding positioning cavity, each second positioning portion is provided in the corresponding positioning groove.

In some embodiments, a side wall of the housing is provided with a plurality of housing positional stopping portions, the first terminal portion of each conductive terminal is provided with a terminal positional stopping portion, the housing positional stopping portion stops a front side of the corresponding terminal positional stopping portion.

In some embodiments, the conductive terminal comprises multiple first conductive terminals and multiple second conductive terminals, the second terminal portions of the multiple second conductive terminals are positioned in front of the second terminal portions of the multiple first conductive terminals; in the first direction, a length of the terminal positional stopping portion of the first conductive terminal is larger than a length of the terminal positional stopping portion of the second conductive terminal.

In some embodiments, two opposite sides of the cover along a width direction each are provided with a clip, the cover is mounted to the rear end of the housing by the two clips, opening side walls of the housing at two opposite sides along the width direction each are provided with a cooperating groove, the clip is partially positioned in the cooperating groove.

In some embodiments, at least one corner of the cover is provided with an avoiding portion, the avoiding portion and opening cavity walls of the housing therebetween have a certain gap.

The electrical connector provided by the present disclosure has the following advantages: the present disclosure provides a structure of an electrical connector, the first terminal portion and the second terminal portion of the conductive terminal of the electrical connector are provided to have an angle therebetween, the housing, the baffle and the cover form a housing assembly which receive the conductive terminals, the rear end of the housing has the opening, the conductive terminal may be mounted into the terminal receiving cavity from the opening, and the cover at least partially covers the opening to protect the conductive terminals, which meets mounting requirement of a non-vertical electrical connector and more facilitates mounting and use, the baffle separates the conductive terminals to achieve isolation among the conductive terminals, and limits mounting positions of the conductive terminals to promote use stability of the conductive terminals.

### BRIEF DESCRIPTION OF THE DRAWINGS

Other features, objects, and advantages of the present disclosure will become more apparent by reading the detailed description of non-limiting embodiments with reference to the accompanying drawings.

FIG. 1 is a perspective view of an electrical connector of an embodiment of the present disclosure;

FIG. 2 is a perspective view of the electrical connector of the embodiment of the present disclosure from another angle;

FIGS. 3 and 4 are exploded views of the electrical connector of the embodiment of the present disclosure;

FIG. 5 is a front view of the electrical connector of the embodiment of the present disclosure;

FIG. 6 is a cross-sectional view taken along a line A-A of FIG. 5;

FIGS. 7 and 8 are perspective views of a housing of the embodiment of the present disclosure;

FIG. 9 is a rear view of the housing of the embodiment of the present disclosure;

FIGS. 10 and 11 are perspective views of a baffle of the embodiment of the present disclosure;

FIGS. 12 and 13 are perspective views of the electrical connector of the embodiment of the present disclosure with a cover omitted;

FIGS. 14 and 15 are perspective views of a first conductive terminal of the embodiment of the present disclosure;

FIG. 16 is a perspective view of the first conductive terminal and a second conductive terminal of the embodiment of the present disclosure;

FIG. 17 is a rear view of the electrical connector of the embodiment of the present disclosure;

FIG. 18 is a perspective view of a baffle of another embodiment of the present disclosure.

### REFERENCE NUMERALS ARE PRESENTED AS FOLLOWS

1 housing
11 terminal receiving cavity
111 first cavity portion
112 second cavity portion
12 opening
13 housing block
14 housing position-limiting portion
15 housing positional stopping portion
16 positioning cavity
17 positioning groove
18 protruding block
191 opening side wall
192 opening top wall
193 cooperating groove
2 baffle
21 baffle body
211 second partitioning structure
22 baffle block
221 first cooperating portion
222 second cooperating portion
223 first position-limiting portion
224 second position-limiting portion
23 first positioning portion
24 second positioning portion
3 cover
31 first partitioning structure
32 clip
33 avoiding portion
6 conductive terminal
61 first terminal portion
62 second terminal portion
63 bending portion
6a first conductive terminal
61a first terminal portion
62a second terminal portion
621a conductive connecting portion
622a cable fixing portion
63a bending portion
64a terminal position-limiting portion
65a terminal positional stopping portion
661a first contact point
662a second contact point
6b second conductive terminal
61b first terminal portion
62b second terminal portion
621b conductive connecting portion
622b cable fixing portion
63b bending portion
64b terminal position-limiting portion
65b terminal positional stopping portion
661b first contact point
662b second contact point

### DETAILED DESCRIPTION

Example embodiments will be more comprehensively described now with reference to the drawings. However, the example embodiments can be implemented in many forms and are not considered to be limited to the embodiments described herein, on the contrary, providing these embodiments makes the present disclosure more thorough and comprehensive, and comprehensively conveys the concept of the example embodiments to a person skilled in that art. The same reference numerals in the figures indicate the same or similar structures, therefore repeated descriptions thereof will be omitted. The term “or” in the specification may indicate “and” or “or”. Although the terms “up”, “down”, “between” and the like may be used in the specification to describe different exemplary features and elements of the present disclosure, these terms are used only for convenience herein, for example, depending on the direction of the examples in the drawings. Any content in this specification should not be understood as requiring a specific three-dimensional orientation of the structure to fall within the scope of the present disclosure. Although the terms “first” or “second” and the like are used in the specification to indicate certain features, they are only intended to indicate function and do not serve as limitations on the number and importance of specific features.

In order to solve the technical problem that a housing which is integrally formed cannot meet mounting requirement of a conductive terminal in a non-vertical electrical connector, the present disclosure provides an electrical connector which can facilitate mounting of conductive terminals and improve use stability of the conductive terminals.

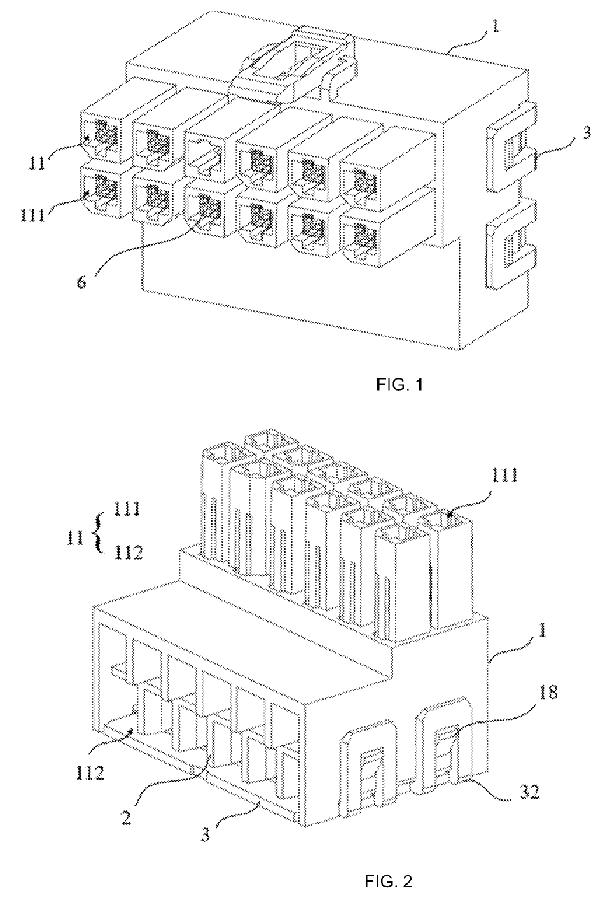

As shown in FIGS. 1 - 4, an embodiment of the present disclosure provides an electrical connector which includes a plurality of conductive terminal 6, a housing 1, a baffle 2 and a cover 3. Each conductive terminal 6 includes a first terminal portion 61 which extends along a first direction and a second terminal portion 62 which extends along a second direction, the first direction and the second direction therebetween have an angle, so the first terminal portion 61 and the second terminal portion 62 are provided not to be parallel to each other, the electrical connector is a non-vertical electrical connector. The housing 1 is provided with a plurality of terminal receiving cavities 11, each conductive terminal 6 is provided in the corresponding terminal receiving cavity 11, a rear end of the housing 1 is provided with an opening 12, each terminal receiving cavity 11 includes a first cavity portion 111 which receives the first terminal portion 61 and a second cavity portion 112 which receives the second terminal portion 62. The baffle 2 is provided in the opening 12 of the housing 1, the baffle 2 is configured to separate the plurality of conductive terminals 6. The cover 3 is assembled to the rear end of the housing 1, and the cover 3 at least partially covers the opening 12.

With the structure of the electrical connector of the present disclosure, the housing 1, the baffle 2 and the cover 3 form a housing assembly which receives the plurality of conductive terminals 6, and the housing 1, the baffle 2 and the cover 3 are components which are separately formed, the rear end of the housing 1 has the opening 12, the plurality of conductive terminals 6 may be mounted into the plurality of terminal receiving cavities 11 from the opening 12, and the cover 3 at least partially covers the opening 12 to protect the plurality of conductive terminals 6, which meets mounting requirement of a non-vertical electrical connector and facilitates mounting and use, the plurality of conductive terminals 6 are physically separated in the housing 1 by the baffle 2, which achieves isolation among the plurality of conductive terminals 6, increases electrical clearance between the conductive terminals 6, and limits mounting positions of the plurality of the conductive terminals 6, and improves use stability of the plurality of the conductive terminals 6.

In the embodiment, the first terminal portion 61 of the conductive terminal 6 is a conductive contacting portion which is used to establish electrical connection with a mating conductive terminal of a mating electrical connector, the second terminal portion 62 is a cable connecting portion which is used to establish electrical connection with a cable which supplies a power. A front side of the electrical connector refers to a side of the electrical connector which is mated with the mating electrical connector, a rear side of the electrical connector refers to a side of the electrical connector which is opposite to the front side along the first direction, the first direction is a front-rear direction, “front” and “rear” here are only exemplary description, it may be understood that, when the electrical connector is turned upside down, the corresponding directions also are turned upside down.

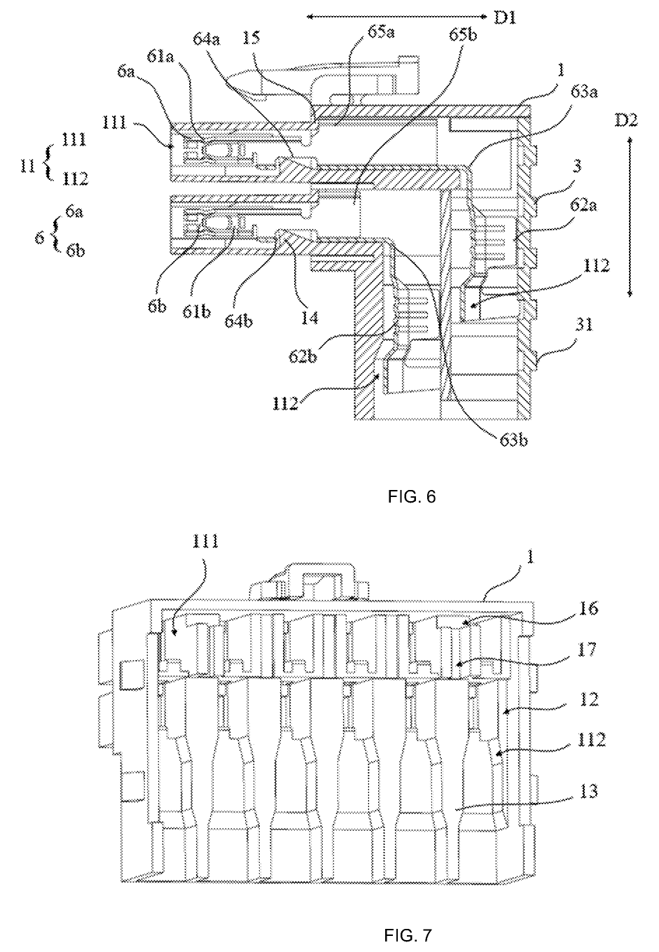

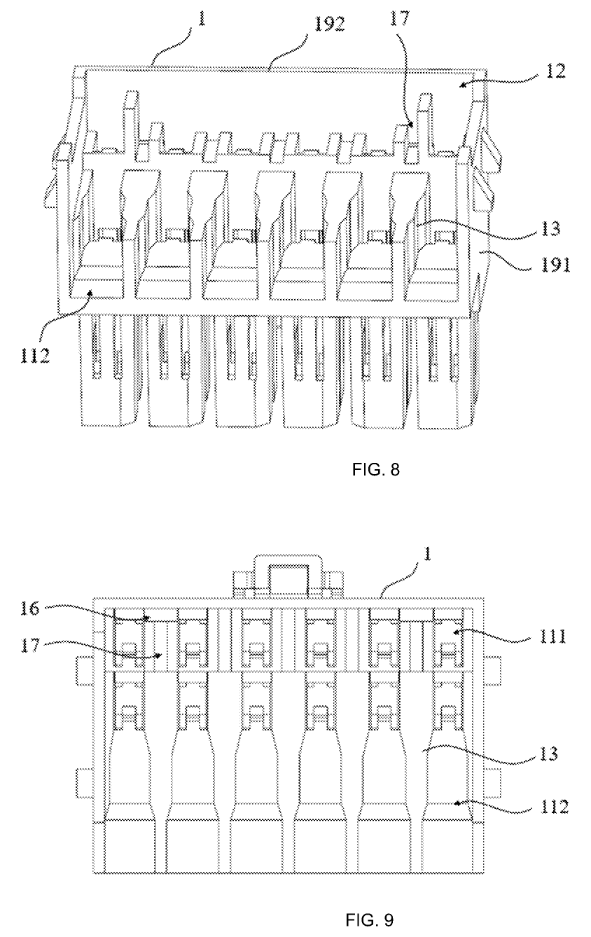

The non-vertical electrical connector refers to an electrical connector in which a conductive contacting portion and a cable connecting portion are provided not to be parallel to each other. The second direction along which the second terminal portion 62 of the present disclosure extends forms an angle with the first direction along which the first terminal portion 61 of the present disclosure extends, rather than being parallel thereto. In some embodiments, as shown in FIGS. 5 and 6, the second direction D2 and the first direction D1 are provided to be perpendicular to each other, that is, the angle between the second direction D2 and the first direction D1 is 90 degrees, the first direction corresponds to the front-rear direction of the electrical connector, the second direction corresponds to a height direction (a longitudinal direction) of the electrical connector of FIG. 1. In other embodiments, the second direction and the first direction therebetween also may form an acute angle, such as 30 degrees, 60 degrees and the like, the second direction is obliquely provided relative to the height direction, a tip of the second terminal portion 62 extends toward the front side relative to an end of the second terminal portion 62 which is connected with the first terminal portion 61. In still other embodiments, the second direction and the first direction therebetween also may form an obtuse angle, such as 120 degrees, 150 degrees and the like, the second direction is obliquely provided relative to the height direction, the tip of the second terminal portion 62 extends toward the rear side relative to the end of the second terminal portion 62 which is connected with the first terminal portion 61. The angle between the first direction and the second direction is configurable according to application requirements.

As shown in FIGS. 1 - 4, the first terminal portion 61 and the second terminal portion 62 of the conductive terminal 6 are connected by a bending portion 63. For example, a manufacturing process of the conductive terminal 6 of the embodiment includes: manufacturing an integral structure that the first terminal portion 61 and the second terminal portion 62 are parallel to each other, crimping the second terminal portion 62 with the cable, bending the second terminal portion 62 relative to the first terminal portion 61 to form the bending portion 63 between the second terminal portion 62 and the first terminal portion 61, the second terminal portion 62 and the first terminal portion 61 are provided therebetween at an angle, and obtaining the conductive terminal 6 which may be used to be mounted in the housing 1.

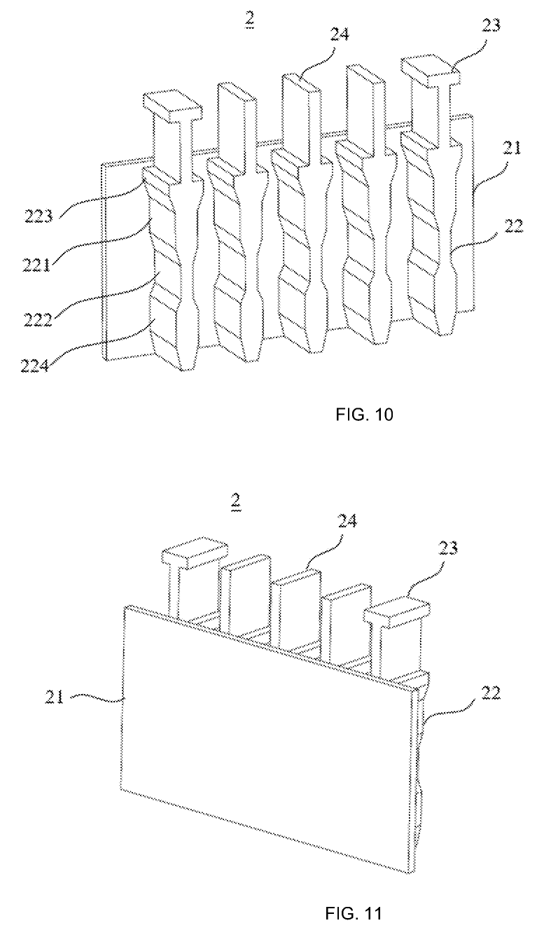

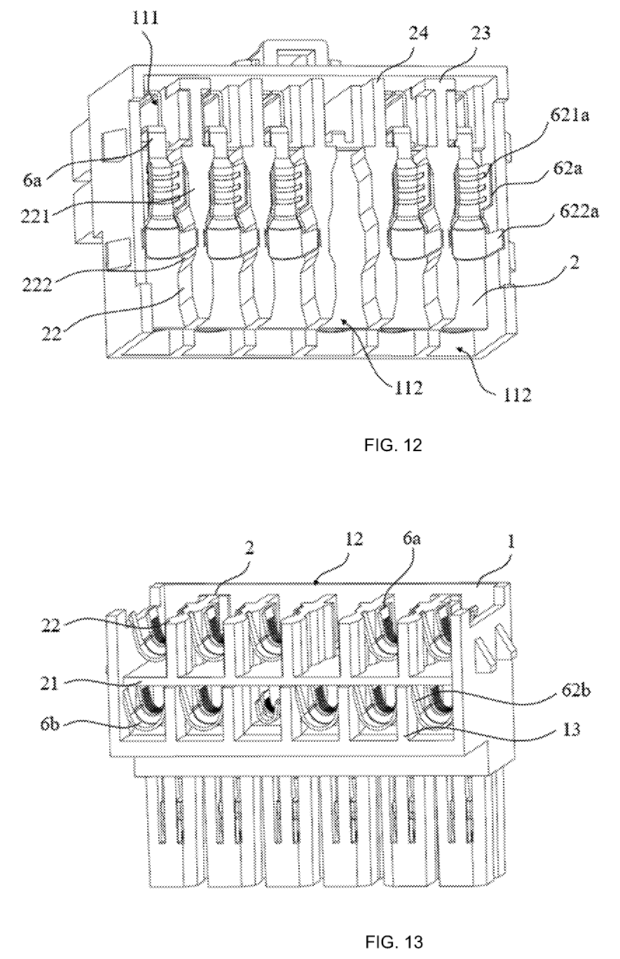

FIGS. 7 - 9 show a structure of the housing 1 of the embodiment, FIGS. 10 and 11 show a structure of the baffle 2 of the embodiment, FIGS. 12 and 13 show a structure that the housing 1, the conductive terminals 6 and the baffle 2 of the embodiment cooperate with each other. As shown in FIG. 6, in some embodiments, the plurality of conductive terminals 6 include multiple first conductive terminals 6a and multiple second conductive terminals 6b. Each first conductive terminal 6a includes a first terminal portion 61a, a second terminal portion 62a and a bending portion 63a, the multiple first conductive terminals 6a are arranged and spaced apart from each other along a width direction. Each second conductive terminal 6b includes a first terminal portion 61b, a second terminal portion 62b and a bending portion 63b, the multiple second conductive terminals 6b are arranged and spaced apart from each other along the width direction. The first terminal portions 61a of the multiple first conductive terminals 6a are positioned above the first terminal portions 61b of the multiple second conductive terminals 6b along the second direction, the second terminal portions 62b of the multiple second conductive terminals 6b are positioned in front of the second terminal portions 62a of the multiple first conductive terminals 6a. Both the multiple first conductive terminals 6a and the multiple second conductive terminals 6b may be provided as power terminals, or a part of the multiple first conductive terminals 6a and a part of the multiple second conductive terminals 6b are power terminals, another part of the multiple first conductive terminals 6a and another part of the multiple second conductive terminals 6b are signal terminals, the number and a position of the power terminal and the number and a position of the signal terminal may be set according to practical application demand. A relationship between the conductive terminals 6 and the terminal receiving cavities 11 is not necessarily one-to-one correspondence relationship, when the conductive terminal 6 does not need to be provided in a terminal receiving cavity 11, the terminal receiving cavity 11 also may be left vacant. As shown in FIGS. 6 - 9, the housing 1 includes multiple housing blocks 13, respective housing blocks 13 therebetween define a second cavity portion 112 which is used to receive the second terminal portion 62b of the second conductive terminal 6b, that is, the multiple housing blocks 13 separate the second terminal portions 62b of the multiple second conductive terminals 6b. As shown in FIGS. 10 - 13, the baffle 2 includes a baffle body 21 and multiple baffle blocks 22, the multiple baffle blocks 22 are provided on a rear side of the baffle body 21, and the multiple baffle blocks 22 are arranged along the width direction. The baffle body 21 is used to physically separate the second terminal portions 62a of the multiple first conductive terminals 6a and the second terminal portions 62b of the multiple second conductive terminals 6b, that is, achieve isolation between the multiple first conductive terminals 6a and the multiple second conductive terminals 6b, and increase electrical clearance between the first multiple conductive terminals 6a and the multiple second conductive terminals 6b. The multiple baffle blocks 22 are used to define the second cavity portions 112 which receive the second terminal portions 62a of the multiple first conductive terminals 6a respectively, that is, physical separate the first conductive terminals 6a of the adjacent second terminal portions 62a, and increase electrical clearance between the first conductive terminals 6a of the adjacent second terminal portions 62a.

Hereinafter, taking the plurality of conductive terminals 6 include the multiple first conductive terminals 6a and the multiple second conductive terminals 6b as example, a structure of each constituent part of the electrical connector is specifically described. In other embodiments, the plurality of conductive terminals 6 also may only include the multiple first conductive terminals 6a, and does not include the multiple second conductive terminals 6b, so the housing 1 does not need to be provided thereon with the multiple housing blocks 13 which separate the multiple second conductive terminals 6b. In still other embodiments, on a basis that the plurality of conductive terminals 6 include the multiple first conductive terminals 6a and the multiple second conductive terminals 6b, the plurality of conductive terminals 6 further may include another conductive terminals, correspondingly, the housing 1 and/or the baffle 2 are provided thereon with a structure which is used to limit the another conductive terminals in position and separate the another conductive terminals.

When the electrical connector is assembled, firstly the multiple second conductive terminals 6b are mounted in the terminal receiving cavities 11 of the housing 1 from the opening 12 of the rear end of the housing 1, then the baffle 2 is mounted in the opening 12 of the rear end of the housing 1, and the baffle 2 at least partially covers the second terminal portions 62b of the multiple second conductive terminals 6b, next the multiple first conductive terminals 6a are mounted in the terminal receiving cavity 11 of the housing 1 from the opening 12 of the rear end of the housing 1, finally the cover 3 is mounted on the rear side of the housing 1, and the cover 3 at least partially covers the opening 12 of the housing 1, the assembling is convenient. After the assembling of the electrical connector is completed, the second terminal portions 62b of the multiple second conductive terminals 6b are limited in position in the front-rear direction respectively by the housing 1 and a front side of the baffle 2, the second terminal portions 62a of the multiple first conductive terminals 6a are limited in position in the front-rear direction respectively by the rear side of the baffle 2 and the cover 3, which thus assures the multiple first conductive terminals 6a and the multiple second conductive terminals 6b of position stability in the front-rear direction. The multiple housing blocks 13 of the housing 1 achieve isolation among the second terminal portions 62b of the multiple second conductive terminals 6b, and limit the second terminal portions 62b of the multiple second conductive terminals 6b in position in the width direction. The baffle body 21 achieves isolation between the multiple second conductive terminals 6b and the multiple first conductive terminals 6a. The multiple baffle blocks 22 of the baffle 2 achieve isolation among the second terminal portions 62a of the multiple first conductive terminals 6a, and limit the second terminal portions 62a of the multiple first conductive terminals 6a in position in the width direction. On one hand, the electrical connector achieves physical isolation between the respective conductive terminals 6, on the other hand, the electrical connector also promotes position stability of each conductive terminal 6 in the width direction.

In conjunction with FIGS. 7, 10 and 12, the rear side of the housing 1 is provided with at least one positioning cavity 16 which extends along the width direction and at least one positioning groove 17 which extends along the second direction, the baffle 2 includes at least one first positioning portion 23 and at least one second positioning portion 24, the first positioning portion 23 is shaped to correspond to the positioning cavity 16, and each first positioning portion 23 is provided in the corresponding positioning cavity 16, the second positioning portion 24 is shaped to correspond to the positioning groove 17, and each second positioning portion 24 is provided in the corresponding positioning groove 17. In some embodiments, the baffle 2 includes the two first positioning portions 23 and multiple second positioning portions 24, each second positioning portion 24 is provided on a top of the corresponding baffle block 22, the two first positioning portions 23 are respectively provided on tops of the two second positioning portions 24 which are positioned at two sides of the multiple second positioning portions 24. Cooperation between the second positioning portion 24 and the positioning groove 17 avoids the baffle 2 moving relative to the housing 1 in the width direction after the assembling of the electrical connector is completed. Cooperation between the first positioning portion 23 and the positioning cavity 16 further avoids the baffle 2 moving relative to the housing 1 in the width direction after the assembling of the electrical connector is completed, at the same time also avoids the baffle 2 moving relative to the housing 1 along the second direction, so that assembling stability between the housing 1 and the baffle 2 is improved. The number and a position of the first positioning portion 23 and the number and a position of the second positioning portion 24 also may be adjusted according to demand, for example, in other embodiments, the top of each second positioning portion 24 is provided with one first positioning portion 23, or, in still other embodiments, the top(s) of a part of the multiple baffle blocks 22 each are provided with the first positioning portion 23, and the top(s) of a part of the multiple baffle blocks 22 each are provided with the second positioning portion 24, or, in further another embodiments, the first positioning portion 23 and/or the second positioning portion 24 are staggered with the multiple baffle blocks 22 in the width direction, so that the first positioning portion 23 and/or the second positioning portion 24 each are not aligned with the corresponding baffle block 22 in the second direction.

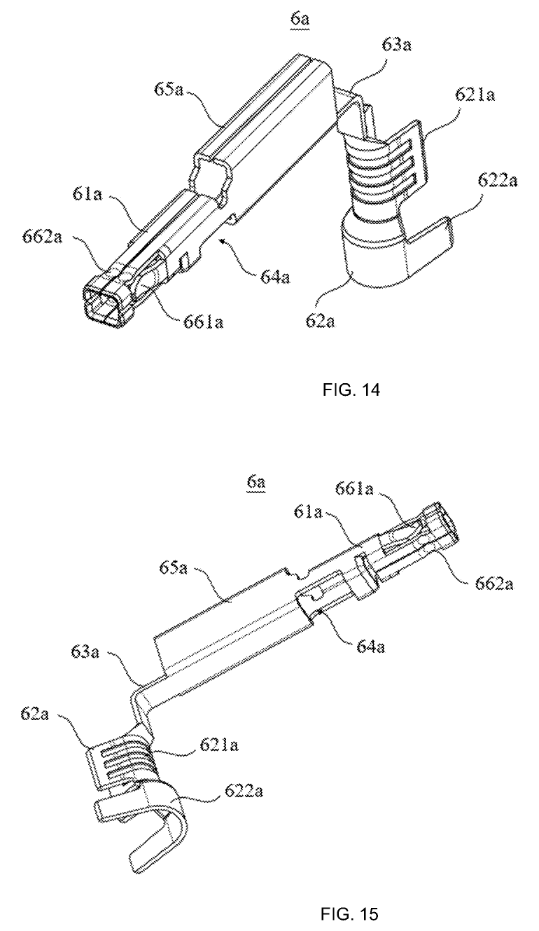

FIGS. 14 - 16 show structures of the conductive terminals of the embodiment. As shown in FIGS. 10 - 16, the second terminal portion 62a of each first conductive terminal 6a includes a conductive connecting portion 621a and a cable fixing portion 622a which are arranged along the second direction. Each baffle 22 includes a first cooperating portion 221 and a second cooperating portion 222 which are arranged along the second direction, the first cooperating portion 221 and the conductive connecting portion 621a face each other in the width direction, that is, a space between the two adjacent first cooperating portions 221 receives the conductive connecting portion 621a of one first conductive terminal 6a, the second cooperating portion 222 and the cable fixing portion 622a face each other in the width direction, that is, a space between the two adjacent second cooperating portions 222 receives the cable fixing portion 622a of one first conductive terminal 6a. In some embodiments, the conductive connecting portion 621a is used to crimp a part of a conductor at a tip of a cable with an insulative jacket of the cable removed, and the cable fixing portion 622a is used to crimp the insulative jacket of the cable. Because the insulative jacket has a certain thickness, a width of the conductive connecting portion 621a is less than a width of the cable fixing portion 622a. Correspondingly, a width of the first cooperating portion 221 of each baffle block 22 is larger than a width of the second cooperating portion 222, so that each side wall of the baffle block 22 forms a concave-convex structure which is shaped to correspond to the first conductive terminal 6a, the baffle block 22 is entirely formed as structure similar to a spindle.

In the embodiment, each baffle block 22 further includes a first position-limiting portion 223 and a second position-limiting portion 224, the first position-limiting portion 223 is positioned at a side (an upper side in FIG. 10) of the first cooperating portion 221 away from the second cooperating portion 222, and the first position-limiting portion 223 is configured to stop the conductive connecting portion 621a of the first conductive terminal 6a in the second direction, that is, prevent the second terminal portion 62a from moving upwardly relative to the baffle block 22 after the assembling of the electrical connector is completed; the second position-limiting portion 224 is positioned at a side (a lower side in FIG. 10) of the second cooperating portion 222 away from the first cooperating portion 221, and the second position-limiting portion 224 is configured to stop the cable fixing portion 622a of the first conductive terminal 6a in the second direction, that is, prevent the second terminal portion 62a from moving downwardly relative to the baffle block 22 after the assembling of the electrical connector is completed, so that the baffle block 22 limits the position of the first conductive terminal 6a in the second direction, in turn improves structure stability of cooperation between the first conductive terminal 6a and the baffle 2.

In conjunction with FIGS. 6 and 14 - 16, a side wall of the first cavity portion 111 of each terminal receiving cavity 11 of the housing 1 is provided with one housing position-limiting portion 14, the first terminal portion 61a of each first conductive terminal 6a is provided with a terminal position-limiting portion 64a, the terminal position-limiting portion 64a and the corresponding housing position-limiting portion 14 form nesting cooperation to limit the first terminal portion 61a to moving rearwardly in the first direction, that is, prevent the first conductive terminal 6a from being withdrawn relative to the housing 1 along the first direction after the assembling of the electrical connector is completed. The first terminal portion 61b of each second conductive terminal 6b is provided with a terminal position-limiting portion 64b, the terminal position-limiting portion 64b and the corresponding housing position-limiting portion 14 form nesting cooperation to limit the first terminal portion 61b to moving rearwardly in the first direction, that is, prevent the second conductive terminal 6b from being withdrawn relative to the housing 1 along the first direction after the assembling of the electrical connector is completed. In some embodiments, the housing position-limiting portion 14 is a protrusion which protrudes from the side wall of the first cavity portion 111, the terminal position-limiting portion 64a is a recessed groove which is provided to the first terminal portion 61a, the terminal position-limiting portion 64b is a recessed groove which is provided to the first terminal portion 61b, each housing position-limiting portion 14 at least partially enters into the corresponding recessed groove. In another embodiment not shown, the housing position-limiting portion 14 also may be a recessed groove which is provided to the side wall of the first cavity portion 111, the terminal position-limiting portion is a protrusion which is provided to the first terminal portion 61 or the second terminal portion 62, which also belongs to be within in the protective scope of the present disclosure.

In conjunction with FIGS. 6 and 14 - 16, a side wall of the housing 1 is provided with a plurality of housing positional stopping portions 15, a rear side surface of the housing positional stopping portion 15 forms a stopping surface, the first terminal portion 61a of each first conductive terminal 6a is provided with a terminal positional stopping portion 65a, the stopping surface of the housing positional stopping portion 15 stops a front side of the terminal positional stopping portion 65a. When the first conductive terminal 6a is inserted into the housing 1, the stopping function of the housing positional stopping portion 15 prevents the first conductive terminal 6a from being inserted into the housing 1 too deeply, so that the first conductive terminal 6a is mounted at a predetermined proper position. The first terminal portion 61b of each second conductive terminal 6b is provided with a terminal positional stopping portion 65b, the stopping surface of the housing positional stopping portion 15 stops a front side of the terminal positional stopping portion 65b, when the second conductive terminal 6b is inserted into the housing 1, the stopping function of the housing positional stopping portion 15 prevents the second conductive terminal 6b from being inserted into the housing 1 too deeply, so that the second conductive terminal 6b is mounted at a predetermined proper position.

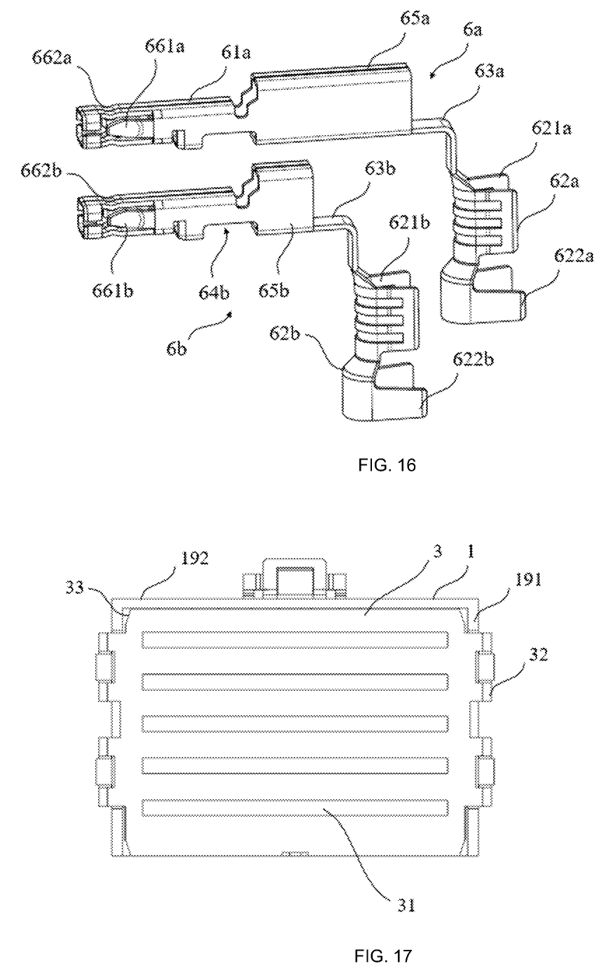

As shown in FIGS. 6 and 16, in the first direction, the first conductive terminal 6a has a bigger space which allows the terminal positional stopping portion 65a to be provided, a length of the terminal positional stopping portion 65a of the first conductive terminal 6a is larger than a length of the terminal positional stopping portion 65b of the second conductive terminal 6b, by that the length of the terminal positional stopping portion 65a of the first conductive terminal 6a is increased, the entire strength of the first conductive terminal 6a may be improved. A side surface of a tip of the first terminal portion 61a of the first conductive terminal 6a is provided with a first contact point 661a, a side surface of a tip of the first terminal portion 61b of the second conductive terminal 6b is provided with a first contact point 661b, the first contact point 661a, 661b is used to establish electrical connection with a mating conductive terminal of the mating electrical connector which is mated with the electrical connector. When the electrical connector is in electrification state and is inserted into or pulled out from the mating electrical connector (that is, hot plugging), a relative large current is likely to be generated between the first contact point 661a, 661b and the mating conductive terminal, after the electrical connector is inserted into or pulled out from the mating electrical connector many times, the first contact point 661a, 661b is easily damaged, so that a contact resistance of the first contact point 661a, 661b is increased, use performance of the conductive terminal is affected. In order to solve the problem, in some embodiments, on a basis that the first contact point 661a, 661b acts as a primary contact point, a top surface and/or a bottom surface of the tip of the first terminal portion 61a of the first conductive terminal 6a each are further provided with a second contact point 662a, and the second contact point 662a is positioned in front of the first contact point 661a in the first direction; a top surface and/or a bottom surface of the tip of the first terminal portion 61b of the second conductive terminal 6b each are further provided with a second contact point 662b, and the second contact point 662b is positioned in front of first contact point 661b in the first direction. In a process that the electrical connector is inserted into the mating electrical connector, the second contact point 662a, 662b acts as an auxiliary contact point, the mating conductive terminal is firstly electrically connected with the second contact point 662a, 662b, and then is electrically connected with the first contact point 661a, 661b; in a process that the electrical connector is pulled out from the mating electrical connector, the mating conductive terminal is firstly released from the electrical connection with the first contact point 661a, 661b, and is then released from the electrical connection with the second contact point 662a, 662b, so that the primary contact point 661a, 661b is protected against being damaged during hot plugging.

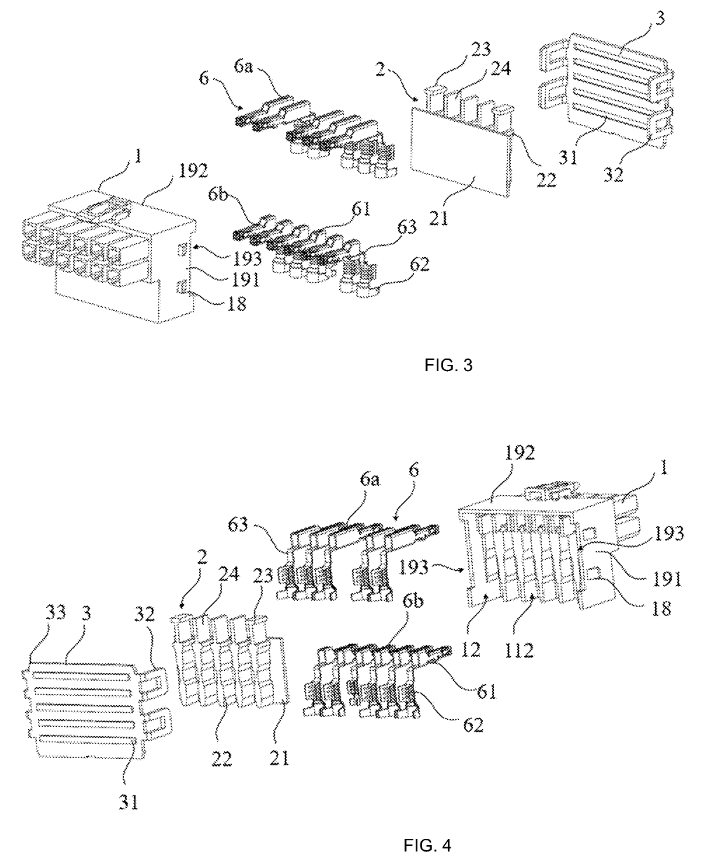

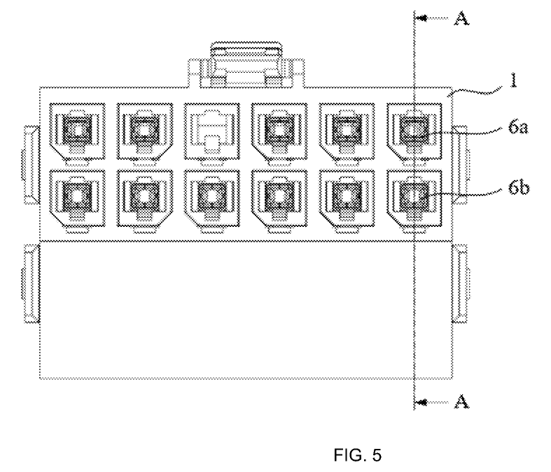

In conjunction with FIGS. 3, 4 and 17, two opposite sides of the cover 3 along the width direction each are provided with a clip 32, outer side walls of the rear end of the housing 1 are provided with two protruding blocks 18 respectively, the two clips 32 are engaged with the two protruding blocks 18 respectively, so that the cover 3 is mounted to the rear end of the housing 1 by the two clips 32, secure connection between the cover 3 and the housing 1 is stabler and more reliable. Opening side walls 191 of the housing 1 at two opposite sides along the width direction each are provided with a cooperating groove 193, the clip 32 is partially positioned in the cooperating groove 193, so that the rear side surface of the housing 1 and a rear side surface of the cover 3 are basically retained in the same plane, which avoids the clip 32 protruding from the rear side surface of the housing 1 to interfere with an external mounting circumstance. The rear side surface of the cover 3 is provided with at least one first partitioning structure 31, each first partitioning structure 31 is a protrusion. As shown in FIG. 17, in some embodiments, the rear side surface of the cover 3 is provided with a plurality of partitioning structures, each first partitioning structure 31 is a structure which protrudes from a front side surface of the cover 3 toward the rear side surface of the cover 3 so that a recessed groove is formed on the front side surface of the cover 3 and a protruding bar is formed on the rear side surface of the cover 3 and extends along the width direction. In other embodiments, each first partitioning structure also may be a structure which is recessed from the front side surface of the cover 3 toward the rear side surface of the cover 3 and protrudes from the rear side surface of the cover 3 and has other shape, the plurality of first partitioning structures also may be a combination of structures having various different shapes. By the provision of the first partitioning structure, the cover 3 has better mounting hand feel and operating hand feel. Moreover, when the plurality of conductive terminals are provided in the electrical connector along the width direction, the rear side surface of the cover 3 is a larger surface, if the rear side surface of the cover 3 is one flat surface, in a process that the cover 3 is formed by inject molding, it is difficult to control uniform flow velocity of a moldflow to be maintained on the whole plane, so it is difficult to assure flatness of the rear side surface of the cover 3 after molding. In order to solve the problem, by that the rear side surface of the cover 3 is provided with at least one first partitioning structure 31, an injection mold for the cover 3 is provided therein with a concave-convex structure which cooperates with the first partitioning structure 31, in the process of inject molding, by cooperation between the first partitioning structure 31 and the concave-convex structure, the rear side surface of the cover 3 is partitioned into moldflow control regions, which is beneficial to promote flatness of the rear side surface of the cover 3. Similarly, flatness of the front side surface of the cover 3 also may be promoted.

As shown in FIG. 17, at least one corner of the cover 3 is provided with an avoiding portion 33, the avoiding portion 33 and opening cavity walls of the housing 1 (an opening top wall 192 and opening side walls 191 of the housing 1) therebetween have a certain gap, which thus avoids each corner of the cover 3 interfering with the housing 1 when the cover 3 is mounted to the rear end of the housing 1. The avoiding portion 33 may be provided with an avoiding structure, such as a chamfer, a bevel, a round or a recessed groove and the like.

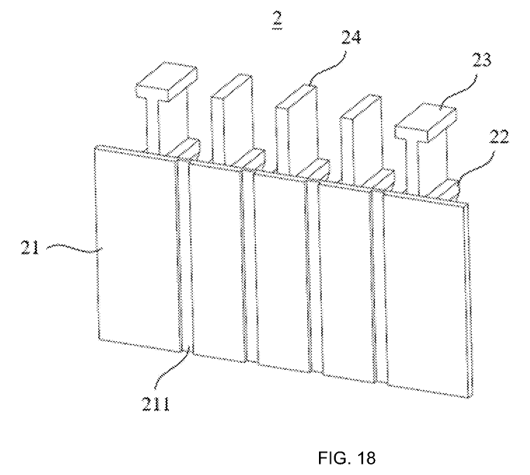

FIG. 18 shows a structure of a baffle 2 of another embodiment of the present disclosure, the another embodiment differs from the foregoing embodiment in that, a front side surface of the baffle body 21 is provided with at least one second partitioning structure 211, each second partitioning structure 211 is a recessed groove or a protrusion. When a plurality of conductive terminals are provided in the electrical connector along the width direction, in order to achieve isolation among the conductive terminals, a width dimension of the baffle 2 is correspondingly provided to be larger, so that the front side surface of the baffle body 21 is a larger surface, if the front side surface of the baffle body 21 is one flat surface, in a process that the baffle 2 is formed by inject molding, it is difficult to control uniform flow velocity of a moldflow to be maintained on the whole plane, so it is difficult to assure flatness of the front side surface of the baffle body 21 after molding. In order to solve the problem, by that the front side surface of the baffle body 21 is provided with at least one second partitioning structure 211, each second partitioning structure 211 is a recessed groove structure which is recessed from a front side surface of the baffle body 21 toward a rear side surface of the baffle body 21. An injection mold for the baffle 2 is provided with a concave-convex structure which cooperates with the second partitioning structure 211, in the process of inject molding, by cooperation between the second partitioning structure 211 and the concave-convex structure, the front side surface of the baffle body 21 is partitioned into moldflow control regions, so as to promote flatness of the front side surface of the baffle body 21. As shown in FIG. 18, in some embodiments, the second partitioning structure 211 is a recessed groove which extends along the second direction. In other embodiments, the second partitioning structure also may be a recessed structure which has an another shape, a direction along which the second partitioning structure extends may be the second direction, the width direction or other direction.

The above content is a further detailed description of the present disclosure in conjunction with the specific preferred embodiments, and it cannot be considered that the specific implementation of the present disclosure is only limited to these description. For ordinary technical personnel in the technical field to which the present disclosure belongs, without departing from the concept of the present disclosure, several simple deductions or substitutions can be made, and should be considered as belonging to the scope of protection of the present disclosure.

What is claimed is:

1. An electrical connector, comprising:
a plurality of conductive terminals, each conductive terminal comprising a first terminal portion which extends along a first direction and a second terminal portion which extends along a second direction, the first direction and the second direction therebetween having an angle;
a housing, the housing being provided with a plurality of terminal receiving cavities, each conductive terminal being provided in the corresponding terminal receiving cavity, a rear end of the housing being provided with an opening;
a baffle provided in the opening of the housing, the baffle being configured to separate the plurality of conductive terminals; and
a cover assembled to the rear end of the housing, the cover at least partially covering the opening.

2. The electrical connector according to claim 1, wherein
the plurality of conductive terminal comprise multiple first conductive terminals which are arranged along a width direction,
the baffle comprises multiple baffle blocks, the multiple baffle blocks are configured to separate the second terminal portions of the multiple first conductive terminals.

3. The electrical connector according to claim 2, wherein
the second terminal portion of each first conductive terminal comprises a conductive connecting portion and a cable fixing portion which are arranged along the second direction,
each baffle block comprises a first cooperating portion and a second cooperating portion which are arranged along the second direction,
the first cooperating portion and the conductive connecting portion face each other in the width direction, the second cooperating portion and the cable fixing portion face each other in the width direction;
a width of the conductive connecting portion is less than a width of the cable fixing portion, a width of the first cooperating portion is larger than a width of the second cooperating portion.

4. The electrical connector according to claim 3, wherein
each baffle block further comprises a first position-limiting portion and a second position-limiting portion,
the first position-limiting portion is positioned at a side of the first cooperating portion away from the second cooperating portion, and the first position-limiting portion is configured to stop the conductive connecting portion in the second direction;
the second position-limiting portion is positioned at a side of the second cooperating portion away from the first cooperating portion, and the second position-limiting portion is configured to stop the cable fixing portion in the second direction.

5. The electrical connector according to claim 1, wherein
the conductive terminal comprises multiple first conductive terminals and multiple second conductive terminals, the second terminal portions of the multiple second conductive terminals are positioned in front of the second terminal portions of the multiple first conductive terminals;
the baffle comprises a baffle body, the baffle body is configured to separate the second terminal portions of the multiple first conductive terminals and the second terminal portions of the multiple second conductive terminals.

6. The electrical connector according to claim 5, wherein
a front side surface of the baffle body is provided with at least one partitioning structure, each partitioning structure is a recessed groove.

7. The electrical connector according to claim 1, wherein
the opening of the housing is provided therein with at least one positioning cavity which extends along a width direction and at least one positioning groove which extends along the second direction,
the baffle comprises at least one first positioning portion and at least one second positioning portion, each first positioning portion is provided in the corresponding positioning cavity, each second positioning portion is provided in the corresponding positioning groove.

8. The electrical connector according to claim 1, wherein
a side wall of the housing is provided with a plurality of housing positional stopping portions,
the first terminal portion of each conductive terminal is provided with a terminal positional stopping portion,
the housing positional stopping portion stops a front side of the corresponding terminal positional stopping portion.

9. The electrical connector according to claim 8, wherein
the conductive terminal comprises multiple first conductive terminals and multiple second conductive terminals,
the second terminal portions of the multiple second conductive terminals are positioned in front of the second terminal portions of the multiple first conductive terminals;
in the first direction, a length of the terminal positional stopping portion of the first conductive terminal is larger than a length of the terminal positional stopping portion of the second conductive terminal.

10. The electrical connector according to claim 1, wherein
two opposite sides of the cover along a width direction each are provided with a clip,
the cover is mounted to the rear end of the housing by the two clips,
opening side walls of the housing at two opposite sides along width direction each are provided with a cooperating groove,
the clip is partially positioned in the cooperating groove.

11. The electrical connector according to claim 1, wherein
at least one corner of the cover is provided with an avoiding portion, the avoiding portion and opening cavity walls of the housing therebetween have a certain gap.
